(19) United States
(12) Patent Application Publication
(10) Pub. No.: US 2013/0235206 A1
(43) Pub. Date: Sep. 12, 2013

(54) System and Method of On-Shelf Inventory Management

(71) Applicant: NUMEREX CORP., Atlanta, GA (US)

(72) Inventors: Jeffrey O. Smith, Dallas, TX (US); Andrew N. Wolverton, Plano, TX (US); Spoorthy Priya Yerabolu, Dallas, TX (US)

(73) Assignee: NUMEREX CORP., Atlanta, GA (US)

(21) Appl. No.: 13/796,676

(22) Filed: Mar. 12, 2013

Related U.S. Application Data
(60) Provisional application No. 61/609,725, filed on Mar. 12, 2012.

(51) Int. Cl. H04N 7/18

(52) U.S. Cl. CPC H04N 7/181; G06Q 10/087
USPC 348/150

(57) ABSTRACT

An inventory management system is described that includes two or more cameras mounted on a retail display space. The cameras are positioned to capture images showing the presence of items of interest in the retail display space. A hub is in communication with each of the cameras mounted on the retail display space and is operable to aggregate information from the cameras related to the items of interest in the retail display space, and to communicate data regarding the status of the item of interest to an inventory management system operable to receive the data from the hub.

### CROSS REFERENCE TO RELATED INFORMATION

This application claims the benefit of U.S. Provisional Patent Application No. 61/609,725, filed Mar. 12, 2012, the contents of which are hereby incorporated herein in its entirety.

### TECHNICAL FIELD

The present disclosure is directed to on-shelf inventory management systems, and more particularly to an on-shelf inventory management system that incorporates sensors, such as cameras and IR sensors into the shelf to track inventory.

### BACKGROUND OF THE INVENTION

Shelf space on which products are being displayed is one of the most important resources in retail environment. Retailers cannot only increase their profit but also decrease cost by proper management of shelf space allocation and products display. Retailers who sell various brands of items through displaying on multi-level shelves face a problem of how to most effectively allocate that shelf space. It is assumed that the level of shelf on which the product is displayed has a significant effect on sales.

Inventory management is a constant problem for retail outlets. With the advent of bar code labels, UPCs, stores have been using the scanning of merchandise at check out to capture the movement of inventory and to initiate actions to replenish shelf stock. However, using sales information at check out can fail to capture the actual status of stock on the shelves. Cash register inventory tracking cannot capture missing shelf stock that results from theft, breakage, misplaced items, or the like. Also, many stores give the responsibility of shelf management to the product distributors or manufacturers and the store inventory system may not be equipped to timely notify the distributors or manufacturers of low, or no stock conditions.

One system, as described in U.S. Pat. No. 6,601,764 to Goodwin describes using RFID to track inventory. Goodwin describes an inventory management system which determines item location and time spent on a shelf The system includes an electronic shelf label (ESL) system including an ESL, a radio frequency identification (RFID) label interrogator associated with the ESL, RFID labels attached to items associated with the ESL, and a computer. The computer uses the ESL system to activate RFID labels on the items, obtains RFID label information from the RFID labels through the ESL system, and stores the RFID label information in a record. The computer completes the process and compares the latest RFID label information with previous RFID label information to determine which items have been added or removed from the shelf.

The problem with RFID systems is that each product placed on the shelf needs to have an RFID tag. This requires either the manufacturer or the store to add those tags to their product and meaningful cost in time and expense.

What is needed is a monitoring system to monitor the status of stock on a shelf or palette and to communicate that information to parties responsible for maintaining shelf inventory. Also, it would be advantageous for the system to learn patterns in inventory conditions to allow the distributor or manufacturer to optimize delivery and stocking schedules.

### BRIEF SUMMARY OF THE INVENTION

In a preferred embodiment of the present invention, an inventory management system is described that includes two or more cameras mounted on a retail display space and positioned to capture images showing the presence of items of interest in the retail display space. A hub is in communication with each of the cameras mounted on the retail display space and is operable to aggregate information from the cameras related to the items of interest in the retail display space, and to communicate data regarding the status of the item of interest. An inventory management system is operable to receive the data from the hub.

In another preferred embodiment of the present invention, a process for managing on-shelf inventory is described that includes capturing an image of a retail display space using a camera mounted in the retail display space. The captured image is processed to determine the nature and quantity of items of interest in the retail display space. Data related to the nature and quantity of items of interest in the retail display space is then sent to an inventory management system using a hub in communication with the camera mounted in the retail display space.

In yet another embodiment, a shelving unit for displaying products for sale is described. The shelving unit includes one or more shelves holding the products for sale and a plurality of cameras mounted in the shelving unit such that the plurality of cameras are operable to capture images of the shelves holding the products for sale. A hub is associated with the shelving unit and is in communication with the plurality of cameras, the hub aggregating data from the plurality of cameras related to the nature and quantity of the products on the one or more shelves.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is perspective view of a retail shelf incorporating various embodiments of the present invention;

FIG. 2 is a block diagram of an embodiment of a camera module according to the concepts described herein;

FIG. 3 is a block diagram of an embodiment of a hub module according to the concepts described herein;

FIG. 4 is a system diagram of an embodiment of a shelf inventory management system according to the concepts described herein; and

FIG. 5 is a flow chart showing an embodiment of a process for managing inventory on a retail store shelf according to the concepts described herein.

### DETAILED DESCRIPTION OF THE INVENTION

Many industry experts agree that overstocks and stock-outs are the most significant contributors to retailers profit erosion. The impact of out-of-stocks extends well beyond the lost sales of the out-of-stock item alone. Out-of-stocks carry with them a variety of costs for both retailers and suppliers, including diminishing brand equity and decreasing effectiveness of trade promotions. Out-of-stocks create a ripple effect by distorting demand and leading to inaccurate forecasts. Retailer costs also include the time employees spend trying to satisfy shoppers who ask about a specific out-of-stock item. For a typical U.S. grocery store, the cost can amount to $800 per week. The corollary for shoppers is the amount of time spent waiting for resolution that could be spent more productively for the retailer in shopping—an estimated 20 percent of the average time for a shopping trip. Successfully managing inventory begins and ends with accurate tracking of the product on the shelf.

To aid in accurately tracking on-shelf inventory, an inventory management system is described for use in tracking and managing on-shelf inventory, particularly in the retail environment. Existing on-shelf management systems use a variety of techniques to try to manage the status of on-shelf inventory. Some systems use cameras mounted above or in front of the shelves, while others use on the shelf sensors such as pressure or capacitive sensors to try to detect the presence of items on the shelf. Still others use RFID (radio frequency ID) tags and sensors. These technologies have their particular strengths and weaknesses, but none have yet proved to be a comprehensive solution.

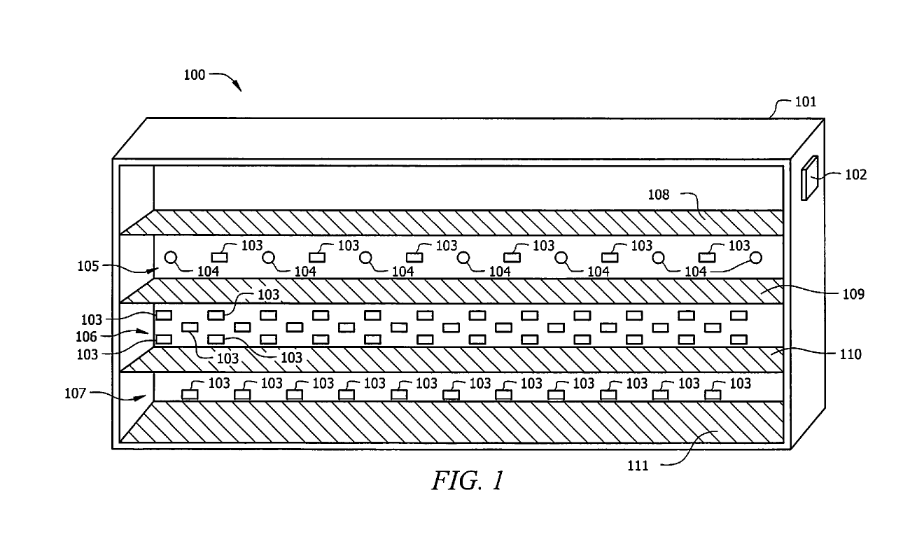

Referring now to FIG. 1, embodiments of an on-shelf inventory management system 100, according to the concepts described herein, uses camera modules and/or infrared (IR) sensors mounted in the shelving itself to detect the presence of product on the shelf. The camera modules 103, shown as rectangles, and/or IR sensors 104, shown as circles, are mounted on the back wall 105, 106, 107 of the shelving module 100 for each shelf 108, 109, 110, 111. While the cameras 103 and IR sensors 104 are shown mounted on the back of the shelving facing forward, they could also be mounted on the top, sides or bottom of the shelving without departing from the scope of the concepts described herein.

The camera modules 103, which can use a camera chip such as the ones found in modern smart phones take images in their field of view and perform image processing looking for familiar shapes, patterns, items or even words and logos. The camera module 103 can even be programmed to compare new images with historical images to look for changes in its field of view. The camera modules 103 can be spaced apart along the length of shelving to provide a complete view of the shelving and images of adjoining camera modules can be stitched together to form a larger image. In addition to linear rows of camera modules 103, as shown on the bottom shelf 111, arrays of camera modules 103 can be used to get greater field of vision and/or image fidelity. An example of an array of camera modules 103 is shown on the second shelf 110, though any pattern of camera sensors can be used and chosen to maximize the characteristics required by the particular application and the type of product being monitored.

In addition to, or instead of, camera modules 103, IR sensors 104 can be used in a similar fashion. IR sensors, such as those used to activate paper towel dispensers, can detect the presence, or absence, of materials in their field of view. The use of IR sensors 104 would result in less data for processing and less nuanced determinations, but can be useful in particular applications. In addition to only camera modules 103, or only IR sensors 104, arrays of combinations of camera sensors and IR sensors can be used to further increase the amount and accuracy of data available. An example of such an array is shown on the third shelf 109 in shelving module 101. As with the camera arrays, the ratio of cameras to IR sensors and the number and placement of each type of sensor can be varied according to application requirements without departing from the scope of the concepts described herein.

In addition to the camera modules 103 and IR sensors 104, a hub 102 can be employed to manage the sensor array and provide a communications link to the system operators. The hub can be associated with a particular set of cameras and sensors, such as those arranged on a typical shelving segment, and multiple hub/sensor arrays can be used in a typical retail store environment. The hub can be used to do data processing on the data from the camera modules 103 and IR sensors 104 and to manage a communication link to an inventory management system. In preferred embodiments, the hub can use cellular communication technology to report data and status to the management system. Since cellular communications are used, it is preferable that the data transmitted by the hub be kept to a minimum to reduce the cost of transmissions. In such an embodiment, the images and sensor data processing would be done at the camera module 103, IR sensor 104 and/or hub 102. The distribution of the data processing can be determined to minimize the costs of the various parts and to maximize the system capabilities.

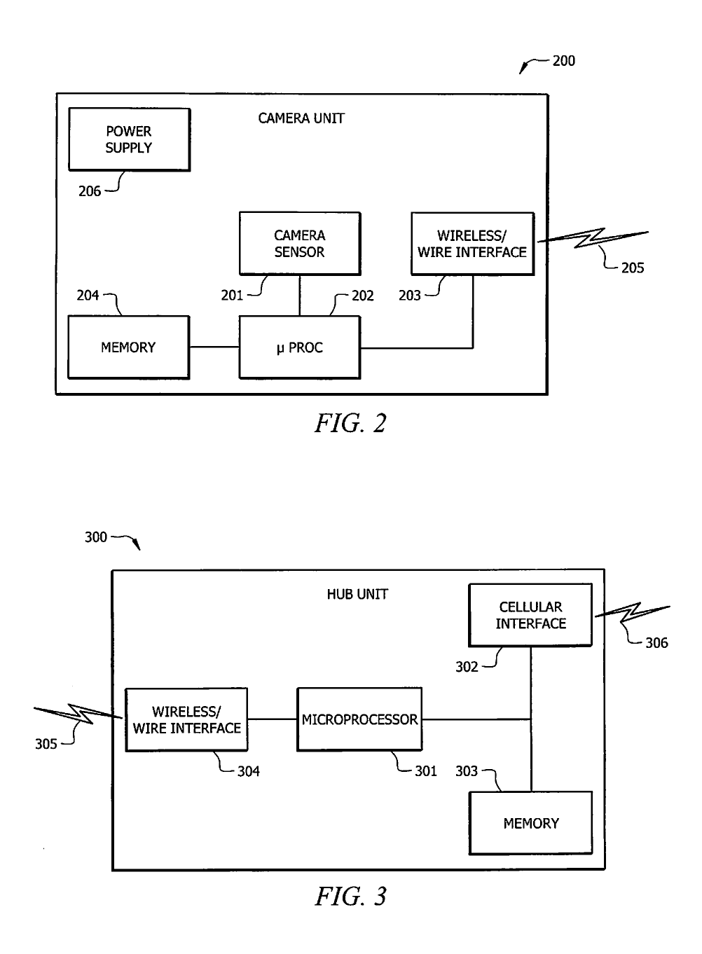

Referring now to FIG. 2, a preferred embodiment of a camera module 200 for use in an on-shelf inventory management system according to the concepts described herein is shown. The camera module 200 includes a camera sensor 201 that captures the images from the ambient light around the device. The camera sensor can by any type of appropriate sensor in any appropriate resolution. The sensor may be of the type or lensed to capture wide angle photographs if required to maximize the field of view. Other configurations of camera are also usable in the system. A microprocessor 202 takes the image data from the camera sensor 201 and can perform some, all or none of the desired image processing. The image processing can include looking for predefined elements, such as shapes, logos, words, etc. within the image and/or comparing the image to historical images to look for changes and patterns. A memory 204 stores historical data, images, configuration information and other programming for the module 200. A wireless or wired interface 203 controls the external communications of the module 200. The module 200 can be linked to the hub 102 shown in FIG. 1 and can also be linked to other modules or sensors to allow the sharing of image data. A power supply 206 provides power to the module 200.

Referring now to FIG. 3, an embodiment of a hub module 300 for use in an on-shelf inventory management system according to the concepts described herein is shown. In preferred embodiments, the hub module 300 aggregates the data from the cameras and sensors and communicates with a back end inventory management system. The connections to the sensors and cameras can be wired or wireless depending on the application and environment. Similarly, the communications with the back end management system can be over any type of wired or wireless network, though in preferred embodiments it is anticipated that the use of cellular networks will be preferred. In using data networks that charge for use, it is preferable that the communications from the hub to the back end management system be kept to a minimum. As such, image processing and other data analysis may be done locally at some combination of the hub, camera module and IR sensor.

In preferred embodiments the hub itself includes a wired or wireless interface 305 with the cameras and sensors using sensor interface module 304. A microprocessor 301 and memory 303 perform the data processing and run the programming for the hub 300, while a communications interface 302, such as a cellular communications interface, controls the sending and receiving of data 306 from the hub to a back end inventory management system.

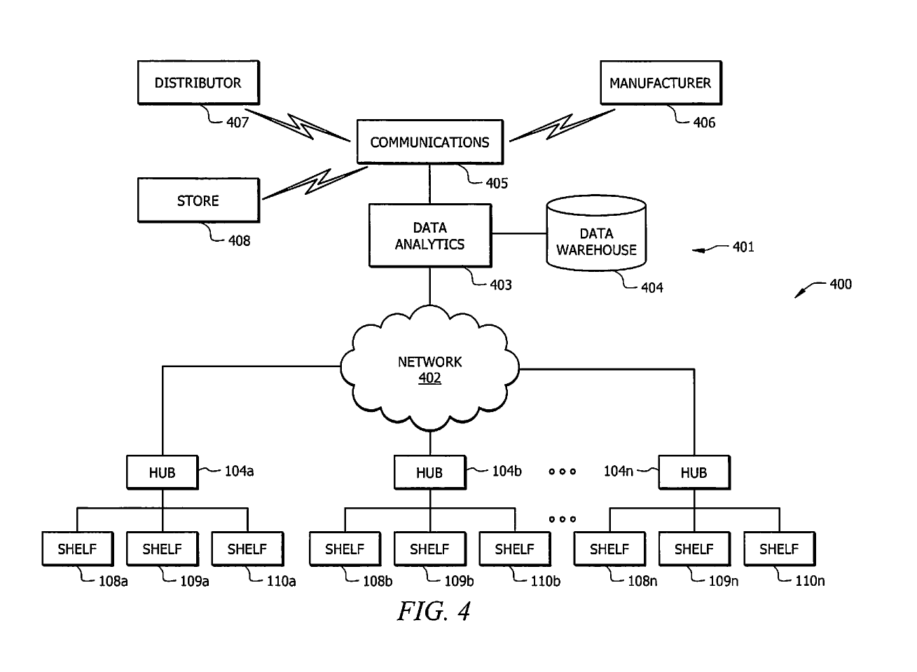

Referring now to FIG. 4, an embodiment of an end-to-end, on-shelf inventory management system 400 is shown. The management system 400 uses the on-shelf cameras and IR sensors, as shown in FIG. 1, to gather and process data about the status of product inventory on monitored shelves, such as shelves 108a-n, 109a-n and 110a-n. That data is passed to an associated hub module 104a through 104n and further processed. The hub 104a through 104n reports the data using, for example, a cellular network 402 to a back end network 401. Back end network 401 stores and processes the data from the hubs and communicates status with interested parties.

Back end network 401 includes data analytics 403 and a data warehouse 404. The data analytics engine 403 can process the data from the hubs to determine outages, low inventory conditions, overstocks and other inventory conditions of interest related to patterns in the inventory status. Such patterns can be used to optimize delivery and stocking times, routes and quantities to maximize efficiency and availability. Data warehouse 404 can store both the raw data from the hubs and can store processed data derived by the data analytics engine 403. Back end network 401 can also be used to notify interested parties using a communications module 405. Interested parties, such as the distributor 407, store 408, and/or product manufacturer 409 can receive reports on the inventory status for the monitored shelf space of interest to that party.

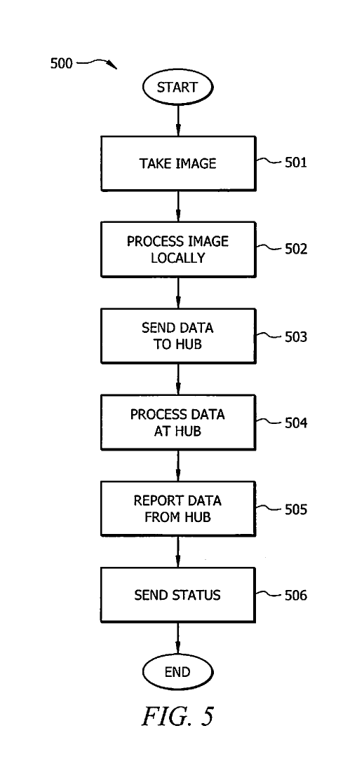

Referring now to FIG. 5, a flow chart of an embodiment of an on-shelf inventory management process is described. Process 500 begins in block 501 where images of shelf space in the field of view of a camera module are taken. The process then passes to block 502 where some, all or none of the captured image is processed at the camera module. The data from the camera module is then sent to a hub associated with multiple camera modules, as shown in block 503. Additional data processing of some, all or none of the images occurs at the hub, as shown in block 504. Relevant data from the hub is then transmitted to a back-end inventory management system, as shown in block 505. The inventory management system is then operable to report the inventory status to interested parties as shown in block 506.

While the use of the inventory management system has been discussed in detail as used on retail shelving space, the system can be used in other contexts and applications while remaining well within the scope of the concepts described herein. In addition to shelf space, the system can be employed for use in gravity feed dispensers, such as those that are used to distribute drinks in convenience stores, end aisle or other palettes where the system could detect the presence and amount of available merchandise. It can also be used with hanging displays in addition to shelves, or in paper or recycling bins. As described, the system can use cameras and IR sensors in any combination and pattern as determined by the requirements of the application. The cameras and IR sensors could also be combined with other types of sensor elements to increase the system capabilities or decrease the costs associated with the system. Other types of sensors could include pressure sensors, capacitive sensors, RFID tags and similar sensors. Other applications could also include monitoring of parking spaces and lots using similar sensors, hubs and methodologies.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An inventory management system comprising:
two or more cameras mounted on a retail display space and positioned to capture images showing the presence of items of interest in the retail display space;
a hub in communication with each of the cameras mounted on the retail display space and operable to aggregate information from the cameras related to the items of interest in the retail display space, and to communicate data regarding the status of the items of interest; and
an inventory management system operable to receive the data from the hub.

2. The inventory management system of claim 1 wherein each of the two or more cameras processes the captured images to extract data regarding the items of interest in the retail display space.

3. The inventory management system of claim 1 wherein each of the hub processes the captured images to extract data regarding the items of interest in the retail display space.

4. The inventory management system of claim 1 wherein both the hub and each of the two or more cameras process the captured images to extract data regarding the items of interest in the retail display space.

5. The inventory management system of claim 1 further comprising IR sensors mounted on the retail display space and used in conjunction with the two or more cameras to determine the status of the items of interest.

6. The inventory management system of claim 1 wherein the inventory management system is operable to communicate the status of the items of interest with one or more of distributors, retailers, stores, and manufacturers having a relationship to the item of interest.

7. The inventory management system of claim 1 wherein the hub communicates with each of the cameras mounted on the retail display space using a wired connection.

8. The inventory management system of claim 1 wherein the hub communicates with each of the cameras mounted on the retail display space using a wireless connection.

9. The inventory management system of claim 1 wherein the hub communicates with the inventory management system using a cellular interface.

10. A process for managing on-shelf inventory comprising:
capturing an image of a retail display space using a camera mounted in the retail display space;
processing the image to determine the nature and quantity of items of interest in the retail display space; and
sending data related to the nature and quantity of items of interest in the retail display space to an inventory management system using a hub in communication with the camera mounted in the retail display space.

11. The process of claim 10 wherein processing the image is performed at the camera.

12. The process of claim 10 wherein processing the image is performed at the hub.

13. The process of claim 10 further comprising IR sensors mounted on the retail display space and used in conjunction with the camera to determine the nature and quantity of the items of interest.

14. The process of claim 10 further comprising communicating the status of the items of interest with one or more of distributors, retailers, stores, and manufacturers having a relationship to the item of interest.

15. The process of claim 10 wherein the hub communicates with the camera using a wired connection.

16. The inventory management system of claim 10 wherein the hub communicates with the camera using a wireless connection.

17. The inventory management system of claim 10 wherein the hub communicates with the inventory management system using a cellular interface.

18. A shelving unit for displaying products for sale comprising:
one or more shelves holding the products for sale;
a plurality of cameras mounted in shelving unit such that the plurality of cameras are operable to capture images of the shelves holding the products for sale; and
a hub associated with the shelving unit and in communication with the plurality of cameras, the hub operable to aggregate data from the plurality of cameras related to the nature and quantity of the products on the one or more shelves.

19. The shelving unit of claim 18 wherein the hub communicates with the plurality of cameras using a wired connection.

20. The shelving unit of claim 18 wherein the hub communicates with the plurality of cameras using a wireless connection.
